(19) United States
(12) Patent Application Publication
(10) Pub. No.: US 2026/0288304 A1
(43) Pub. Date: Sep. 24, 2026

(54) DISPLAY CONTROL DEVICE, DISPLAY CONTROL METHOD, AND STORAGE MEDIUM

(71) Applicant: HONDA MOTOR CO., LTD., Tokyo (JP)

(72) Inventor: Takashi Noguchi, Tokyo (JP)

(21) Appl. No.: 19/447,776

(22) Filed: Jan. 13, 2026

(30) Foreign Application Priority Data
Mar. 19, 2025 (JP) 2025-044335

(51) Int. Cl. G06F 3/0482; G06F 3/04817

(52) U.S. Cl. CPC G06F 3/0482; G06F 3/04817

(57) ABSTRACT

A display control device includes a display control part displaying a first display screen or a second display screen on a display, the first display screen selectively displaying icons of a first number of two or more respectively corresponding to apps of the first number, each of the apps being distributing a content, and the second display screen selectively displaying icons of a second number of two or more respectively corresponding to contents of the second number, a display setting part setting a display screen to be displayed on the display to the first display screen or the second display screen, and a history storage part for storing a display history of the first and second display screens, in which the display setting part sets the display screen to be displayed on the display to the first display screen or the second display screen based on the display history.

### INCORPORATION BY REFERENCE

The present application claims priority under 35 U.S.C. § 119 to Japanese Patent Application No. 2025-044335 filed on Mar. 19, 2025. The content of the application is incorporated herein by reference in its entirety.

### BACKGROUND OF THE INVENTION

### Field of the Invention

The present invention relates to a display control device, a display control method, and a storage medium.

### Description of the Related Art

Japanese Patent Laid-Open No. 2021-77994 discloses a technology for acquiring a usage frequency of each classification of an application program, acquiring a provision frequency of each classification of a content corresponding to the application program from the usage frequency, and determining an allocation of a case number of a recommended content to be notified to a receiving device for each classification of the content based on the provision frequency.

However, the technology disclosed in Japanese Patent Laid-Open No. 2021-77994 assumes that a user selects a content after selecting an application program (hereinafter, described as an app-based UI (User Interface)). However, in recent years, a system has been disclosed for selecting a content without selecting an application program (hereinafter, described as a “content-focused UI”).

In other words, there is a problem of suitably setting an app-based UI and a content-focused UI.

### SUMMARY OF THE INVENTION

As a first aspect for achieving this objective, a display control device is provided that includes a display control part for displaying a first display screen or a second display screen on a display, the first display screen selectively displaying icons of a first number of two or more that respectively correspond to apps of the first number, each of the apps being for distributing a content, and the second display screen selectively displaying icons of a second number of two or more that respectively correspond to contents of the second number, a display setting part for setting a display screen to be displayed on the display to the first display screen or the second display screen, and a history storage part for storing a display history of the first display screen and the second display screen, in which the display setting part sets the display screen to be displayed on the display to the first display screen or the second display screen based on the display history.

As a second aspect for achieving this objective, a display control method is provided that is a display control method of a display control device including: a display control part for displaying a first display screen or a second display screen on a display, the first display screen selectively displaying icons of a first number of two or more that respectively correspond to apps of the first number, each of the apps being for distributing a content, and the second display screen selectively displaying icons of a second number of two or more that respectively correspond to contents of the second number, a display setting part for setting a display screen to be displayed on the display to the first display screen or the second display screen, and a history storage part for storing a display history of the first display screen and the second display screen, the display control method including performing a setting step of setting, by the display setting part, a display screen to be displayed on the display to the first display screen or the second display screen based on the display history.

As a third aspect for achieving this objective, a non-transitory computer readable storage medium storing a display control program is provided for causing a processor of a display control device to function as: a display control part for displaying a first display screen or a second display screen on a display, the first display screen selectively displaying icons of a first number of two or more that respectively correspond to apps of the first number, each of the apps being for distributing a content, or the second display screen selectively displaying icons of a second number of two or more that respectively correspond to contents of the second number, a display setting part for setting a display screen to be displayed on the display to the first display screen or the second display screen, and a history storage part for storing a display history of the first display screen and the second display screen, in which the display setting part sets the display screen to be displayed on the display to the first display screen or the second display screen based on the display history.

According to the display control device, the display control method, and the storage medium described above, an app-based UI and a content-focused UI can be suitably set.

### BRIEF DESCRIPTION OF THE DRAWINGS

FIG. 1 is a plan view showing an example of a configuration of a vehicle mounted with a display control device relating to a present embodiment;

FIG. 2 is a figure showing an example of a configuration of the display control device relating to the present embodiment;

FIG. 3 is a screen view showing an example of a configuration of a first display screen and a second display screen;

FIG. 4 is a chart showing an example of a display history;

FIG. 5 is a figure showing an example of a first region and a second region;

FIG. 6 is a graph showing an example of a transition in a display frequency of the second display screen; and

FIG. 7 is a flowchart showing an example of processes of the display control device relating to the present embodiment.

### DETAILED DESCRIPTION OF THE INVENTION

Hereinafter, embodiments of a display control device, a display control method, and a display control program will be described, by referring to the figures.

### 1. Configuration of the Vehicle

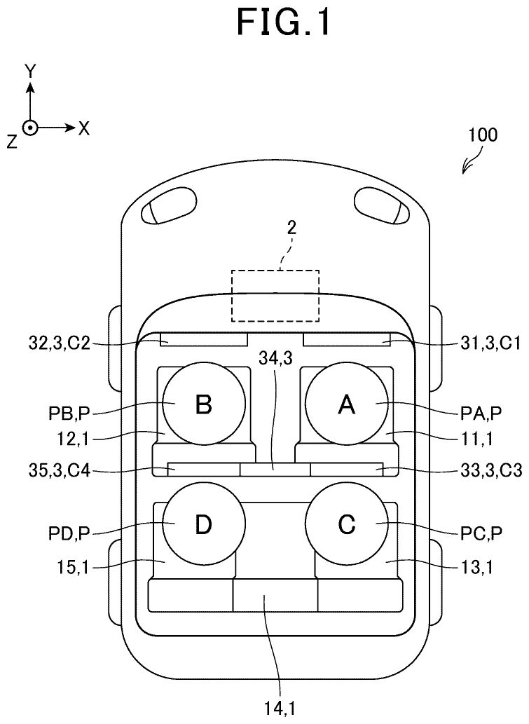

Next, a configuration of a vehicle 100 mounted with a display control device 2 relating to a present embodiment will be described, by referring to FIG. 1. FIG. 1 is a plan view showing an example of the vehicle 100 mounted with the display control device 2 relating to the present embodiment.

FIG. 1 shows an X-axis, a Y-axis, and a Z-axis that are mutually orthogonal to each other. The X-axis and the Y-axis are parallel to a horizontal direction. The Z-axis is parallel to a vertical direction. The X-axis is parallel to a left-right direction of the vehicle 100. The Y-axis is parallel to a front-rear direction of the vehicle 100. A positive direction of the X-axis shows a right-side direction of the vehicle. A positive direction of the Y-axis shows a front-side direction of the vehicle. A positive direction of the Z-axis shows an upper-side direction of the vehicle.

FIG. 1 shows a plan view of the vehicle 100 in a state where a roof is detached.

As shown in FIG. 1, the vehicle 100 includes a seat 1, a display control device 2, and an output mechanism 3.

In the present embodiment, the seat 1 is configured of a first seat 11, a second seat 12, a third seat 13, a fourth seat 14, and a fifth seat 15.

The first seat 11 and the second seat 12 are arranged on the front side in the vehicle 100. The first seat 11 and the second seat 12 constitute a front seat. The third seat 13, the fourth seat 14, and the fifth seat 15 are arranged on the rear side of the first seat 11 and the second seat 12 in the vehicle 100. The third seat 13, the fourth seat 14, and the fifth seat 15 constitute a rear seat.

The first seat 11 is a driver's seat arranged on the right side in the front seat. A passenger PA sits in the first seat 11. The passenger PA is, for example, a driver. In the present embodiment, the driver is included in the passengers P. The second seat 12 is a passenger seat arranged on the left side of the first seat 11. A passenger PB sits in the second seat 12.

The third seat 13 is a seat arranged on the right side in the rear seat. In the present embodiment, a passenger PC sits in the third seat 13. The fourth seat 14 is a seat arranged in the middle part in the rear seat. In the present embodiment, a passenger P does not sit in the fourth seat 14.

The fifth seat 15 is a seat arranged on the left side in the rear seat. In the present embodiment, a passenger PD sits in the fifth seat 15. Note that, in the following description, in a case where the first seat 11, the second seat 12, the third seat 13, the fourth seat 14, and the fifth seat 15 are not distinguished from each other, there may be cases where the seats are collectively described as a seat 1.

The output mechanism 3 is configured of a first output mechanism 31, a second output mechanism 32, a third output mechanism 33, a fourth output mechanism 34, and a fifth output mechanism 35.

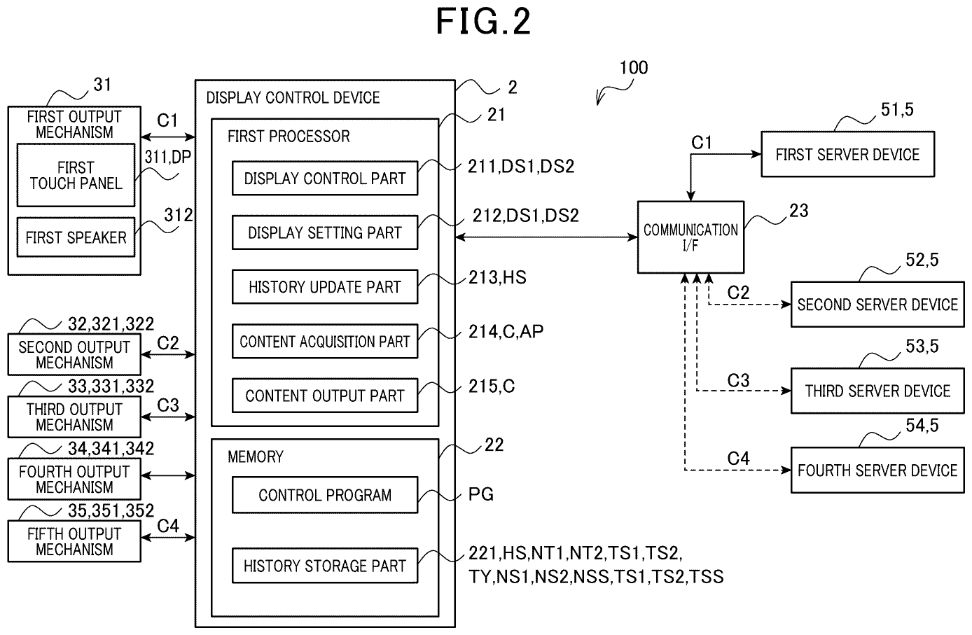

As described by referring to FIG. 2, the first output mechanism 31 includes a first touch panel 311 and a first speaker 312. The second output mechanism 32 includes a second touch panel 321 and a second speaker 322. The third output mechanism 33 includes a third touch panel 331 and a third speaker 332. The fourth output mechanism 34 includes a fourth touch panel 341 and a fourth speaker 342. The fifth output mechanism 35 includes a fifth touch panel 351 and a fifth speaker 352.

The first output mechanism 31 is arranged, for example, on a dashboard in front of the first seat 11. The first touch panel 311 of the first output mechanism 31 is arranged so that a display surface of the first touch panel 311 faces the passenger PA. In other words, the first touch panel 311 of the first output mechanism 31 is arranged so that the display surface of the first touch panel 311 faces a rear direction.

The first touch panel 311 and the first speaker 312 output a content C1, in accordance with an instruction from the display control device 2. The first touch panel 311 displays an image included in the content C1. The first speaker 312 outputs a voice included in the content C1.

Note that, in the present embodiment, since the passenger PA is the driver, the first touch panel 311 is prohibited from a display of an image, while the passenger PA is driving. However, in a case where the vehicle 100 is automatically driven, the first touch panel 311 is not prohibited from a display of an image. In the present embodiment, automatic driving means automatic driving of “Level 3” or more prescribed by SAE (Society of Automotive Engineers).

The second output mechanism 32 is arranged, for example, on a dashboard in front of the second seat 12. The second touch panel 321 of the second output mechanism 32 is arranged so that a display surface of the second touch panel 321 faces the passenger PB seated in the second seat 12. In other words, the second touch panel 321 of the second output mechanism 32 is arranged so that the display surface of the second touch panel 321 faces a rear direction.

The second touch panel 321 and the second speaker 322 output a content C2, in accordance with an instruction from the display control device 2. The second touch panel 321 and the second speaker 322 output the content C2. The second touch panel 321 displays an image included in the content C2. The second speaker 322 outputs a voice included in the content C2.

The third output mechanism 33 is arranged, for example, on a back surface of the first seat 11 in front of the third seat 13, that is, the third output mechanism 33 is arranged on a back surface of a backrest of the first seat 11. The third touch panel 331 of the third output mechanism 33 is arranged so that a display surface of the third touch panel 331 faces the passenger PC. In other words, the third touch panel 331 of the third output mechanism 33 is arranged so that the display surface of the third touch panel 331 faces a rear direction.

The third touch panel 331 and the third speaker 332 output a content C3, in accordance with an instruction from the display control device 2. The third touch panel 331 displays an image included in the content C3. The third speaker 332 outputs a voice included in the content C3.

The fourth output mechanism 34 is arranged, for example, on a back surface of the first seat 11 and a back surface of the second seat 12 in front of the fourth seat 14. The fourth touch panel 341 of the fourth output mechanism 34 is arranged so that a display surface of the fourth touch panel 341 faces the passenger P seated in the fourth seat 14. In other words, the fourth touch panel 341 of the fourth output mechanism 34 is arranged so that the display surface of the fourth touch panel 341 faces a rear direction.

The fourth touch panel 341 and the fourth speaker 342 output a content C, in accordance with an instruction from the display control device 2. The fourth touch panel 341 displays an image included in the content C. The fourth speaker 342 outputs a voice included in the content C. In the present embodiment, since the passenger P is not seated in the fourth seat 14, the fourth touch panel 341 and the fourth speaker 342 do not output the content C.

The fifth output mechanism 35 is arranged, for example, on a back surface of the second seat 12 in front of the fifth seat 15. The fifth touch panel 351 of the fifth output mechanism 35 is arranged so that a display surface of the fifth touch panel 351 faces the passenger PD. In other words, the fifth touch panel 351 of the fifth output mechanism 35 is arranged so that the display surface of the fifth touch panel 351 faces a rear direction.

The fifth touch panel 351 and the fifth speaker 352 output a content C4, in accordance with an instruction from the display control device 2. The fifth touch panel 351 displays an image included in the content C4. The fifth speaker 352 outputs a voice included in the content C4.

The display control device 2 acquires the content C1 from a first server device 51 shown in FIG. 2. Moreover, the display control device 2 outputs the content C1 to the first touch panel 311 and the first speaker 312 of the first output mechanism 31. Moreover, the display control device 2 acquires the content C2 from a second server device 52 shown in FIG. 2. Moreover, the display control device 2 outputs the content C2 to the second touch panel 321 and the second speaker 322 of the second output mechanism 32.

Moreover, the display control device 2 acquires the content C3 from a third server device 53 shown in FIG. 2. Moreover, the display control device 2 outputs the content C3 to the third touch panel 331 and the third speaker 332 of the third output mechanism 33. Moreover, the display control device 2 acquires the content C4 from a fourth server device 54 shown in FIG. 2. Moreover, the display control device 2 outputs the content C4 to the fifth touch panel 351 and the fifth speaker 352 of the fifth output mechanism 35.

The content C1, the content C2, the content C3, and the content C4 are, for example, mutually different content of the content C.

A configuration of the display control device 2 will be further described by referring to FIG. 2.

In the present embodiment, while a case has been described in which there are four passengers P, that is, the passenger PA, the passenger PB, the passenger PC, and the passenger PD, the embodiment is not limited to this. For example, there may be three or less passengers P. Moreover, for example, there may be five or more passengers P.

### 2. Configuration of the Display Control Device

Next, a configuration of the display control device 2 relating to the present embodiment will be described, by referring to FIG. 2. FIG. 2 is a figure showing an example of a configuration of the display control device 2 relating to the present embodiment.

As shown in FIG. 2, the display control device 2 is communicatively connected to the first output mechanism 31, the second output mechanism 32, the third output mechanism 33, the fourth output mechanism 34, and the fifth output mechanism 35.

The first output mechanism 31 includes the first touch panel 311 and the first speaker 312.

The first touch panel 311 includes a display DP such as an LCD (Liquid Crystal Display) and a touch sensor. The display DP outputs various images, in accordance with an instruction of the display control device 2. The touch sensor is integrally formed with a display surface of the display DP, and the touch sensor detects a touch operation of the passenger P. The touch sensor outputs a signal to the display control device 2, the signal showing a detected touch operation.

The first speaker 312 outputs various voices, in accordance with an instruction of the display control device 2.

The second output mechanism 32 includes the second touch panel 321 and the second speaker 322. The third output mechanism 33 includes the third touch panel 331 and the third speaker 332. The fourth output mechanism 34 includes the fourth touch panel 341 and the fourth speaker 342. The fifth output mechanism 35 includes the fifth touch panel 351 and the fifth speaker 352.

Each of the second touch panel 321, the third touch panel 331, the fourth touch panel 341, and the fifth touch panel 351 has a configuration approximately the same as the configuration of the first touch panel 311.

In the following description, in a case where the first touch panel 311, the second touch panel 321, the third touch panel 331, the fourth touch panel 341, and the fifth touch panel 351 are not distinguished from each other, there may be cases where the touch panels are collectively described as a “touch panel TP”.

Each of the second speaker 322, the third speaker 332, the fourth speaker 342, and the fifth speaker 352 has a configuration approximately the same as the configuration of the first speaker 312.

In the following description, in a case where the first speaker 312, the second speaker 322, the third speaker 332, the fourth speaker 342, and the fifth speaker 352 are not distinguished from each other, there may be cases where the speakers are collectively described as a “speaker SP”.

The display control device 2 is configured of, for example, an ECU (Electronic Control Unit). The display control device 2 includes a processor 21, a memory 22, and a communication interface 23.

The communication interface 23 includes an antenna, a connector, and an interface circuit, and the communication interface 23 is connected to the processor 21. The communication interface 23 is an interface for communicating with a server device 5 (computer). The communication interface 23 is an interface that performs wireless communication with the server device 5, for example, in accordance with 4G standards, 5G standards, or Wi-Fi (registered trademark) standards.

The server device 5 includes the first server device 51, the second server device 52, the third server device 53, and the fourth server device 54.

The first server device 51 transits the content C1 to the display control device 2, in accordance with a request from the display control device 2. The second server device 52 transmits the content C2 to the display control device 2, in accordance with a request from the display control device 2. The third server device 53 transmits the content C3 to the display control device 2, in accordance with a request from the display control device 2. The fourth server device 54 transmits the content C4 to the display control device 2, in accordance with a request from the display control device 2.

The first server device 51, the second server device 52, the third server device 53, and the fourth server device 54 each have a configuration that is approximately the same as each other. In a case where each of the first server device 51, the second server device 52, the third server device 53, and the fourth server device 54 is not distinguished from each other, there may be cases where the server devices are collectively described as a server device 5.

In the above description, while a case has been described in which the display control device 2 acquires four contents C, that is, the content C1, the content C2, the content C3, and the content C4, the display control device 2 is not limited to this. The display control device 2 may acquire at least one content C. The display control device 2 may acquire, for example, one content C. Moreover, for example, the display control device 2 may acquire, for example, two contents C. Moreover, for example, the display control device 2 may acquire, for example, three contents C.

Moreover, for example, the display control device 2 may acquire, for example, five or more contents C.

Note that, in the following description, for the sake of convenience, a case will mainly be described in which the display control device 2 acquires one content C. The content C is acquired from the server device 5, based on an instruction of a user, and the content C is output to the output mechanism 3.

The “user” is, for example, the passenger PA, the passenger PB, the passenger PC, or the passenger PD.

The output mechanism 3 is, for example, the first output mechanism 31, the second output mechanism 32, the third output mechanism 33, or the fifth output mechanism 35.

The processor 21 is configured of a CPU or an MPU. The processor 21 may be configured of a single processor, or the processor 21 can be configured of a plurality of processors. The memory 22 is configured of, for example, a non-volatile semiconductor memory or a volatile and non-volatile semiconductor memory. The memory 22 stores a control program PG.

The control program PG corresponds to an example of a “display control program”.

The display control device 2 includes a display control part 211, a display setting part 212, a history update part 213, a content acquisition part 214, a content output part 215, and a history storage part 221.

The processor 21 functions as the display control part 211, the display setting part 212, the history update part 213, the content acquisition part 214, and the content output part 215, by executing the control program PG stored in the memory 22. Moreover, the processor 21 functions as the history storage part 221, by executing the control program PG stored in the memory 22.

The history storage part 221 stores a display history HS of the first display screen DS1 and the second display screen DS2. The first display screen DS1 selectively displays icons JA of a first number N1 of two or more. Each of the icons JA of the first number N1 corresponds to one app (=application program) AP from among apps AP of the first number N1, each of the apps AP for distributing the content C. The second display screen DS2 selectively displays icons JC of a second number N2 of two or more. Each of the icons JC of the second number N2 corresponds to one content C from among contents C of the second number N2.

The display history HS of the first display screen DS1 and the second display screen DS2 is stored in the history storage part 221, by the history update part 213.

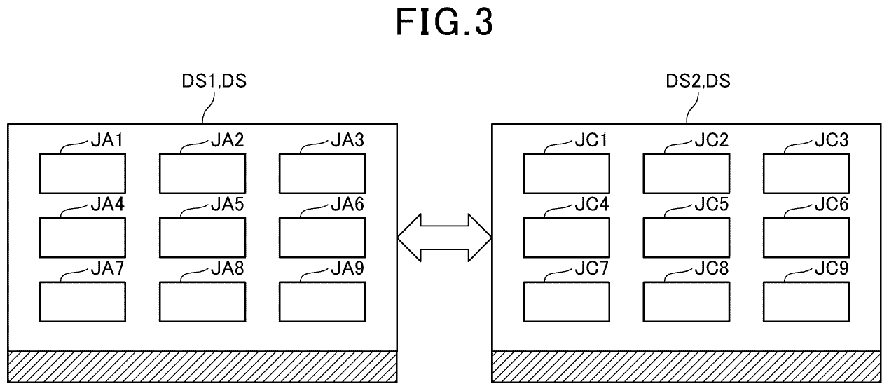

The first display screen DS1 and the second display screen DS2 will be further described by referring to FIG. 3.

Note that, in the present embodiment, there may be cases where the “application program” is described as an “app”, for the sake of convenience.

The display control part 211 displays the first display screen DS1 or the second display screen DS2 on the display DP. The display DP constitutes, for example, the first touch panel 311.

The display setting part 212 sets the display screen DS to be displayed on the display DP to the first display screen DS1 or the second display screen DS2, based on the display history HD.

In a case where the display setting part 212 sets the display screen DS to be displayed on the display DP to the first display screen DS1, the display setting part 212 causes the display control part 211 to display the first display screen DS1 on the display DP. In a case where the display setting part 212 sets the display screen DS to be displayed on the display DP to the second display screen DS2, the display setting part 212 causes the display control part 211 to display the second display screen DS2 on the display DP.

The history update part 213 updates the display history HS of the first display screen DS1 and the second display screen DS2 stored in the history storage part 221.

The content acquisition part 214 is communicatively connected to the server device 5, via the communication interface 23, based on an instruction of the user with respect to the first display screen DS1 or the second display screen DS2, and the content acquisition part 214 acquires the content C from the server device 5.

The content output part 215 outputs the content C with respect to the user seated in the seat 1 of the vehicle 100. The content output part 215 outputs, for example, the content C to the first output mechanism 31, the content C being acquired by the content acquisition part 214.

Here, the first display screen DS1 and the second display screen DS2 will be described, by referring to FIG. 3. FIG. 3 is a screen view showing an example of a configuration of the first display screen DS1 and the second display screen DS2.

As shown on the left side of FIG. 3, the first display screen DS1 selectively displays the icons JA of the first number N1. The first number N1 is, for example, 20.

The icons JA include, for example, a first icon JA1 to a ninth icon JA9. Each of the first icon JA1 to the ninth icon JA9 corresponds to one app AP from among the apps AP of the first number N1, each of the apps AP for distributing the content C. For example, the first icon JA1 corresponds to a first app AP1. Moreover, for example, the second icon JA2 corresponds to a second app AP2. Similarly, the Nth icon JAN corresponds to an Nth app APN (N=1−N1).

The first display screen DS1 corresponds to an example of an “app-based UI”.

Moreover, the first display screen DS1 corresponds to, for example, an example of an “Android TV (registered trademark)” display screen DS.

For example, in a case where the first icon JA1 is touch-operated by the user, the first app AP1 is executed, and the display control device 2 is communicatively connected to the server device 5 corresponding to the first app AP1. The server device 5 corresponds to an example of an application server device that provides a so-called “content distribution service”.

Similarly, in a case where the Nth icon JAN (N=1−N1) is touch-operated by the user, the Nth app APN is executed, and the display control device 2 is communicatively connected to the server device 5 corresponding to the Nth app APN.

As shown on the right side of FIG. 3, the second display screen DS2 selectively displays the icons JC of the second number N2. The second number N2 is, for example, 1,000,000.

The icons JC includes, for example, a first icon JC1 to a ninth icon JC9. Each of the first icon JC1 to the ninth icon JC9 corresponds to one content C from among the contents C of the second number N2. For example, the first icon JC1 corresponds to a first content C1. Moreover, for example, the second icon JC2 corresponds to a second content C2. Similarly, the Nth icon JCN corresponds to an Nth content CN (N=1−N2).

The second display screen DS2 corresponds to an example of a “content-focused UI”.

Moreover, the second display screen DS2 corresponds to, for example, an example of a “Google TV (registered trademark)” display screen DS.

For example, in a case where the first icon JC1 is touch-operated by the user, the display control device 2 is communicatively connected to the server device 5 that provides contents C including the first content C1. The server device 5 corresponds to an example of an application server device that provides a so-called “content distribution service”.

Note that, in a case where there are a plurality of server devices 5 present that provide content C including the first content C1, for example, the display control device 2 is communicatively connected to a recommended server device 5. Moreover, for example, the display control device 2 may allow the user to select what service to use from among a plurality of “content distribution services”.

Similarly, in a case where the Nth icon JCN (N=1−N2) is touch-operated by the user, the display control device 2 is communicatively connected to the server device 5 that provides the Nth content CN.

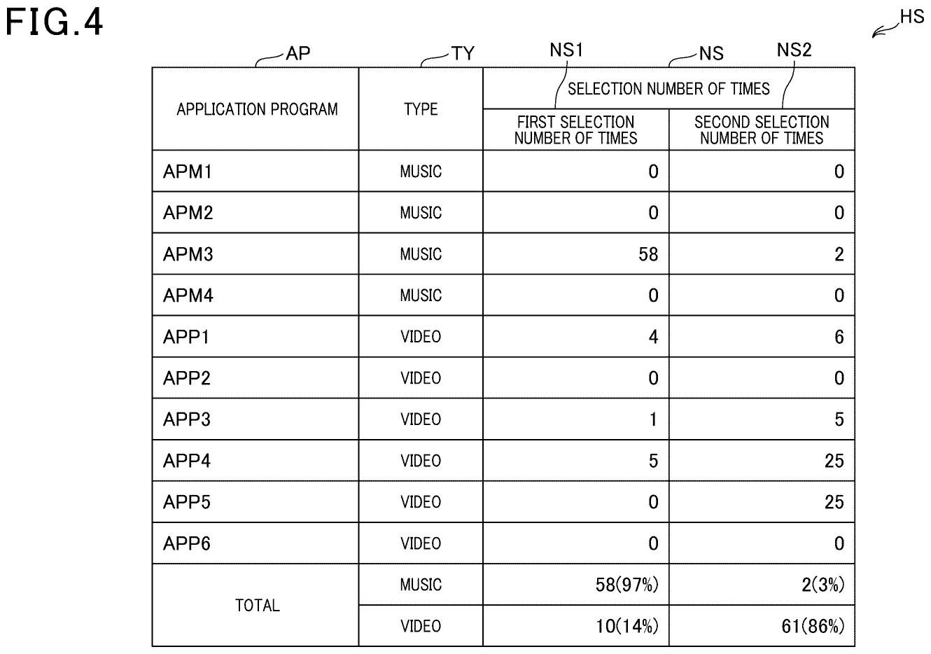

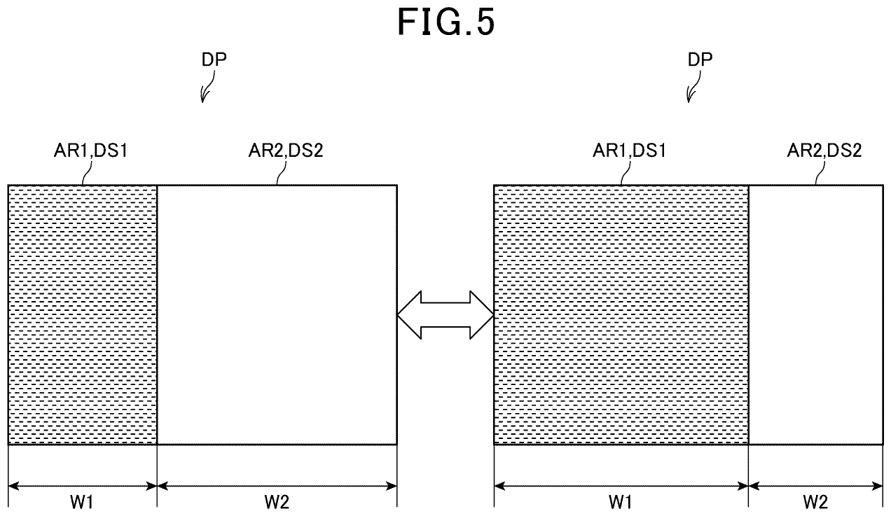

Heretofore, while a basic configuration of the present embodiment has been described, by referring to FIG. 1 to FIG. 3, the present embodiment is not limited to this. The present embodiment includes a first embodiment described by referring to FIG. 2, a second embodiment described by referring to FIG. 2, FIG. 4, and FIG. 5, other modified examples of the first embodiment and the second embodiment, a third embodiment described by referring to FIG. 2, and other modified examples of the third embodiment.

### 2-1. First Embodiment of the Display Control Device

Next, returning to FIG. 2, a configuration of the display control device 2 will be described. First, a first embodiment of the display control device 2 will be described, by referring to FIG. 2.

The history storage part 221 stores, for example, a first number of times NT1 and a second number of times NT2, as the display history HS. The history storage part 221 stores, for example, the first number of times NT1 and the second number of times NT2, as the display history HS, in association with identification information of the user. The first number of times NT1 is a number of times that the user selects one app AP from among the apps AP of the first number N1 on the first display screen DS1. The second number of times NT2 is a number of times that the user selects one content C from among the contents C of the second number N2 on the second display screen DS2.

In this case, the history update part 213 updates the first number of times NT1, by reading out the first number of times NT1 stored in the history storage part 221 and incrementing the first number of times NT1 by only “1”, when the user selects one app AP from the apps AP of the first number N1 on the first display screen DS1.

Moreover, the history update part 213 updates the second number of times NT2, by reading out the second number of times NT2 stored in the history storage part 221 and incrementing the second number of times NT2 by only “1”, when the user selects one content C from the contents C of the second number N2 on the second display screen DS2.

The display setting part 212 sets the display screen DS to a display screen DS corresponding to a more numerous number of times from among the first number of times NT1 and the second number of times NT2. That is, in a case where the display setting part 212 has the first number of times NT1 being more numerous than the second number of times NT2, the display setting part 212 sets the display screen DS to the first display screen DS1 shown in FIG. 3. Moreover, in a case where the display setting part 212 has the second number of times NT2 being more numerous than the first number of times NT1, the display setting part 212 sets the display screen DS to the second display screen DS2 shown in FIG. 3.

In this way, since in a case where the first number of times NT1 is more numerous than the second number of times NT2, the display setting part 212 sets the display screen DS to the first display screen DS1, and in a case where the second number of times NT2 is more numerous than the first number of times NT1, the display setting part 212 sets the display screen DS to the second display screen DS2, the first display screen DS1 and the second display screen DS2 can be suitably set.

Moreover, the history storage part 221 stores, for example, a first cumulative time TS1 and a second cumulative time TS2, as the display history HS. The history storage part 221 stores, for example, the first cumulative time TS1 and the second cumulative time TS2, as the display history HS, in association with identification information of the user. The first cumulative time TS1 is a cumulative time that the first display screen DS1 is displayed on the display DP. Moreover, the second cumulative time TS2 is a cumulative time that the second display screen DS2 is displayed on the display DP.

In this case, the history update part 213 detects a time TD1 that the first display screen DS1 is displayed, when the display control part 211 displays the first display screen DS1 on the display DP. Also, at a time when the display control part 211 ends a display of the first display screen DS1, the history update part 213 updates the first cumulative time TS1, by reading out the first cumulative time TS1 stored in the history storage part 221 and adding the time TD1 to the first cumulative time TS1.

Moreover, the history update part 213 detects a time TD2 that the second display screen DS2 is displayed, when the display control part 211 displays the second display screen DS2 on the display DP. Also, at a time when the display control part 211 ends a display of the second display screen DS2, the history update part 213 updates the second cumulative time TS2, by reading out the second cumulative time TS2 stored in the history storage part 221 and adding the time TD2 to the second cumulative time TS2.

Moreover, in a case where a sum TSS of the first cumulative time TS1 and the second cumulative time TS2 is equal to or more than a first time threshold TH1, the display setting part 212 sets the display screen DS to be displayed on the display DP to the first display screen DS1 or the second display screen DS2. The first time threshold TH1 is, for example, “24 hours”.

In this way, in a case where the sum TSS of the first cumulative time TS1 and the second cumulative time TS2 is equal to or more than the first time threshold TH1, the display setting part 212 sets the display screen DS to the first display screen DS1 or the second display screen DS2. Therefore, the first display screen DS1 and the second display screen DS2 can be suitably set, at a time when a sufficient number of times is accumulated, as the first number of times NT1 and the second number of times NT2, by suitably setting the first time threshold TH1.

Moreover, in a case where the first cumulative time TS1 or the second cumulative time TS2 is less than a second time threshold TH2, the second time threshold TH2 being smaller than the first time threshold TH1, the display setting part 212 may perform the following processes. That is, the display setting part 212 sets the display screen DS to be displayed on the display DP to a display screen DS for which the cumulative time is less than the second time threshold TH2. For example, in a case where the first cumulative time TS1 is less than the second time threshold TH2, the display setting part 212 sets the first display screen DS1. Moreover, for example, in a case where the second cumulative time TS2 is less than the second time threshold TH2, the display setting part 212 sets the second display screen DS2. The second time threshold TH2 is, for example, “5 hours”.

In this way, in a case where the first cumulative time TS1 is less than the second time threshold TH2, the display setting part 212 sets the first display screen DS1, and in a case where the second cumulative time TS2 is less than the second time threshold TH2, the display setting part 212 sets the second display screen DS2. Accordingly, a display screen DS for which the cumulative time is less than the second time threshold TH2 can be set. Therefore, the first number of times NT1 and the second number of times NT2 can quickly reach a sufficient number of times. As a result of this, the convenience of the user can be improved.

### 2-2. Second Embodiment of the Display Control Device

Next, a second embodiment of the display control device 2 will be described, by referring to FIG. 2, FIG. 3, and FIG. 4.

Each of the apps AP of the first number N1 is classified into one of a plurality of types TY, and each of the contents C of the second number N2 is classified into one of the plurality of types TY.

The plurality of types TY include video and music.

In the following description, a case will be described in which the plurality of types TY are video and music.

The history storage part 221 stores a first selection number of times NS1 and a second selection number of times NS2, as the display history HS. The history storage part 221 stores the first selection number of times NS1 and the second selection number of times NS2, as the display history HS, for example, in association with identification information of the user.

The first selection number of times NS1 is a number of times that the user selects the app AP, by classifying one app AP selected by the user for each of the plurality of types TY, on the first display screen DS1. In other words, the first selection number of times NS1 is a number of times that the user selects the app AP, for each type TY corresponding to the one app AP selected by the user, on the first display screen DS1. The second selection number of times NS2 is a number of times that the user selects the content C, by classifying one content C selected by the user for each of the plurality of types TY, on the second display screen DS2. In other words, the second selection number of times NS2 is a number of times that the user selects the content C, for each type TY corresponding to the one content C selected by the user, on the second display screen DS2.

In this case, the history update part 213 determines the type TY corresponding to one app AP, when the user selects the one app AP from the apps AP of the first number N1, on the first display screen DS1. Also, the history update part 213 updates the first selection number of times NS1, by incrementing the first selection number of times NS1 corresponding to the determined type TY by only “1”.

Moreover, the history update part 213 determines the type TY corresponding to one content C, when the user selects the one content C from the contents C of the second number N2, on the second display screen DS2. Also, the history update part 213 updates the second selection number of times NS2, by incrementing the second selection number of times NS2 corresponding to the determined type TY by only “1”.

The display setting part 212 determines a sum NSS of the first selection number of times NS1 and the second selection number of times NS2, the first selection number of times NS1 corresponding to each of the plurality of types TY and the second selection number of times NS2 corresponding to each of the plurality of types TY. Also, the display setting part 212 sets the display screen DS, for the type TY with a most numerous sum NSS, to a display screen DS corresponding to a more numerous selection number of times from among the first selection number of times NS1 and the second selection number of times NS2, in each of the plurality of types TY. That is, in a case where the display setting part 212 has the first selection number of times NS1 being more numerous than the second selection number of times NS2, the display setting part 212 sets the display screen DS, for the type TY with a most numerous sum NSS, to the first display screen DS1. Moreover, in a case where the display setting part 212 has the second selection number of times NS2 being more numerous than the first selection number of times NS1, for the type TY with a most numerous sum NSS, the display setting part 212 sets the display screen DS to the second display screen DS2.

In this way, in a case where the first selection number of times NS1 is more numerous than the second selection number of times NS2, the display setting part 212 sets the display screen DS, for the type TY with a most numerous sum NSS, to the first display screen DS1. Moreover, in a case where the second selection number of times NS2 is more numerous than the first selection number of times NS1, the display setting part 212 sets the display screen DS, for the type TY with a most numerous sum NSS, to the second display screen DS2. Therefore, the first display screen DS1 and the second display screen DS2 can be suitably set, in accordance with the first selection number of times NS1 and the second selection number of times NS2, in the type TY with a most numerous sum NSS.

Here, the first selection number of times NS1 and the second selection number of times NS2 will be further described, by referring to FIG. 4. FIG. 4 is a chart showing an example of the display history HS.

In FIG. 4, the app AP, the type TY, the first selection number of times NS1, and the second selection number of times NS2 are shown, as the display history HS, from the left side toward the right side.

“APM1” to “APM4” of the app AP column have a type TY that is “music”. For example, in a case where the app AP is “APM3”, the first selection number of times NS1 is “58 times”, and the second selection number of times NS2 is “2 times”.

“APP1” to “APP6” of the app AP column have a type TY that is “video”. In a case where the app AP is “APP4”, the first selection number of times NS1 is “5 times”, and the second selection number of times NS2 is “25 times”.

For example, as described in the row of “total” of FIG. 4, in a case where the type TY is “music”, the first selection number of times NS1 is “58 times”, and the second selection number of times NS2 is “2 times”. Accordingly, the sum NSS corresponding to the type TY of “music” is “60 times”. Moreover, in a case where the type TY is “video”, the first selection number of times NS1 is “10 times”, and the second selection number of times NS2 is “61 times”. Accordingly, the sum NSS corresponding to the type TY of “video” is “71 times”. Therefore, the type TY with a most numerous sum NSS is “video”.

Moreover, in a case where the type TY is “video”, the first selection number of times NS1 is “10 times”, and the second selection number of times NS2 is “61 times”. That is, in “video” that is the type TY with a most numerous sum NSS, the second selection number of times NS2 is more numerous than the first selection number of times NS1. Therefore, the display setting part 212 sets the display screen DS to the second display screen DS2 shown in FIG. 3.

Next, modified examples of the second embodiment of the display control device 2 will be described, by referring to FIG. 2, FIG. 3, FIG. 4, and FIG. 5. The modified examples of the second embodiment of the display control device 2 have a different configuration of the display setting part 212, compared to the second embodiment of the display control device 2 that is described above.

In a modified example of the second embodiment of the display control device 2, the display setting part 212 has the following configuration.

The display setting part 212 determines the one type TY corresponding to a selected app AP or content C, from among the plurality of types TY, when the user selects the one app AP or the one content C. Also, the display setting part 212 sets the display screen DS to a display screen corresponding to a more numerous selection number of times, from among the first selection number of times NS1 and the second selection number of times NS2, the first selection number of times NS1 corresponding to the one type TY and the second selection number of times NS2 corresponding to the one type TY. That is, in a case where the display setting part 212 has the first selection number of times NS1 being more numerous than the second selection number of times NS2, the first selection number of times NS1 corresponding to the one type TY, the display setting part 212 sets the display screen DS to the first display screen DS1. Moreover, in a case where the display setting part 212 has the second selection number of times NS2 being more numerous than the first selection number of times NS1, the second selection number of times NS2 corresponding to the one type TY, the display setting part 212 sets the display screen DS to the second display screen DS2.

In this way, in a case where the first selection number of times NS1 is more numerous than the second selection number of times NS2, the first selection number of times NS1 corresponding to one type TY that corresponds to the selected app AP or content C, the display setting part 212 sets the display screen DS to the first display screen DS1. Moreover, in a case where the second selection number of times NS2 is more numerous than the first selection number of times NS1, the second selection number of times NS2 corresponding to one type TY that corresponds to the selected app AP or content C, the display setting part 212 sets the display screen DS to the second display screen DS2. Therefore, the first display screen DS1 and the second display screen DS2 can be suitably set, in accordance with the one type TY corresponding to the app AP or the content C.

For example, as described in “total” of FIG. 4, in a case where the type TY is “music”, the first selection number of times NS1 is “58 times”, and the second selection number of times NS2 is “2 times”. Moreover, in a case where the type TY is “video”, the first selection number of times NS1 is “10 times”, and the second selection number of times NS2 is “61 times”.

That is, in the case shown in FIG. 4, in a case where the type TY is “music”, the first selection number of times NS1 is more numerous than the second selection number of times NS2, and in a case where the type TY is “video”, the second selection number of times NS2 is more numerous than the first selection number of times NS1. Accordingly, in a case where the one type TY corresponding to the app AP or the content C is “music”, the display setting part 212 sets the display screen DS to the first display screen DS1 shown in FIG. 3. Moreover, in a case where the one type TY corresponding to the app AP or the content C is “video”, the display setting part 212 sets the display screen DS to the second display screen DS2 shown in FIG. 3.

Moreover, in a modified example of the second embodiment of the display control device 2, the display control part 211 and the display setting part 212 may have the following configurations.

That is, in a case where the display setting part 212 sets the display screen DS to the first display screen DS1, the display control part 211 displays the first display screen DS1 on a first region AR1 set beforehand on the display DP. Moreover, in a case where the display setting part 212 sets the display screen DS to the second display screen DS2, the display control part 211 displays the second display screen DS2 on a second region AR2 set beforehand on the display DP, the second region AR2 being different from the first region AR1.

FIG. 5 is a figure showing an example of the first region AR1 and the second region AR2.

As shown in FIG. 5, the first region AR1 and the second region AR2 are set on the display DP. The display control part 211 displays the first display screen DS1 on the first region AR1 of the display DP. The display control part 211 displays the second display screen DS2 on the second region AR2 of the display DP.

In FIG. 5, the first region AR1 is illustrated with hatching. As shown on the left side of FIG. 5, a width W2 of the second region AR2 may be larger than a width W1 of the first region AR1, and as shown on the right side of FIG. 5, the width W1 of the first region AR1 may be larger than the width W2 of the second region AR2.

In the case shown in FIG. 4, in a case where the type TY is “music”, the first display screen DS1 is displayed, and in a case where the type TY is “video”, the second display screen DS2 is displayed.

Accordingly, for example, the size of the first region AR1 and the size of the second region AR2 may be set in accordance with the sum TSS of the first cumulative time TS1 and the second cumulative time TS2 of a case where the type TY is “music”, and the size of the first region AR1 and the size of the second region AR2 may be set in accordance with the sum TSS of the first cumulative time TS1 and the second cumulative time TS2 of a case where the type TY is a “video”.

For example, the first region AR1 is displayed larger as the sum TSS of the first cumulative time TS1 and the second cumulative time TS2 increases, the sum TSS of the first cumulative time TS1 and the second cumulative time TS2 being of a case where the type TY is “music”. Moreover, for example, the second region AR2 is displayed larger as the sum TSS of the first cumulative time TS1 and the second cumulative time TS2 increases, the sum TSS of the first cumulative time TS1 and the second cumulative time TS2 being of a case where the type TY is a “video”.

In this way, since the first region AR1 and the second region AR2 are set on the display DP, the convenience of the user can be improved.

### 2-3. Third Embodiment of the Display Control Device

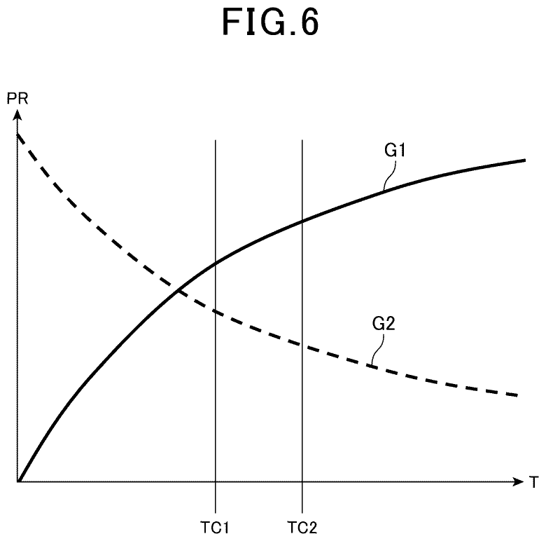

Next a third embodiment of the display control device 2 will be described, by referring to FIG. 2, FIG. 3, and FIG. 6.

The first display screen DS1 or the second display screen DS2 is configured so that a display content is changed, in association with identification information of the user.

As described by referring to FIG. 3, the first display screen DS1 corresponds to, for example, an example of an “Android TV (registered trademark)” display screen DS, and the second display screen DS2 corresponds to, for example, an example of a “Google TV (registered trademark)” display screen DS.

Here, a case will be described in which the second display screen DS2 is a “Google TV (registered trademark)” display screen DS. In this case, the second display screen DS2 is configured so that a display content is changed, in association with identification information of the user. The second display screen DS2 analyses, for example, a viewing history or preferences for each user, based on identification information of the user, and the second display screen DS2 displays recommended content C for each user. This function is called “curation”.

The display setting part 212 sets with priority a display screen DS with the display content changed, as the display screen DS to be displayed on the display DP. That is, the display setting part 212 displays the second display screen DS2 with more priority than the first display screen DS1.

In this way, since the display setting part 212 sets with priority a display screen DS with the display content changed, as the display screen DS to be displayed on the display DP, the convenience of the user can be improved.

Moreover, in a case where a display frequency of the display screen DS with the display content changed has an increasing tendency, in the display history HS stored by the history storage part 221, the display setting part 212 may set the display screen DS with the display content changed, as the display screen DS to be displayed on the display DP.

The display screen DS with the display content changed is, for example, the second display screen DS2.

Here, a determination method of whether or not the display frequency of the second display screen DS2 has an increasing tendency will be described, by referring to FIG. 6. FIG. 6 is a graph showing an example of a transition in a display frequency PR of the second display screen DS2.

The horizontal axis of the graph shown in FIG. 6 shows a time T, and the vertical axis shows a display frequency PR of the second display screen DS2. The display frequency PR of the second display screen DS2 is, for example, a ratio of the display number of times of the second display screen DS2 with respect to the display number of times of the first display screen DS1 and the second display screen DS2 for each day.

For example, a case will be described in which it is determined whether or not the display frequency of the second display screen DS2 has an increasing tendency, at a time TC2 after one week has elapsed from a time TC1.

As shown in graph G1, in a case where a tendency is positive, that is, in a case where the display frequency PR of the second display screen DS2 at the time TC2 is larger than the display frequency PR of the second display screen DS2 at the time TC1, it is determined that the display frequency PR of the second display screen DS2 has an increasing tendency.

As shown in graph G2, in a case where a tendency is negative, that is, in a case where the display frequency PR of the second display screen DS2 at the time TC2 is smaller than the display frequency PR of the second display screen DS2 at the time TC1, it is determined that the display frequency PR of the second display screen DS2 does not have an increasing tendency.

In this way, in a case where the display frequency PR of the second display screen DS2 has an increasing tendency, it can be assumed that the graph shows the user beginning to understand a good convenience of the second display screen DS2. Therefore, since the display setting part 212 sets the second display screen DS2, the second display screen DS2 can be suitably displayed.

### 3. Processes of the Display Control Device

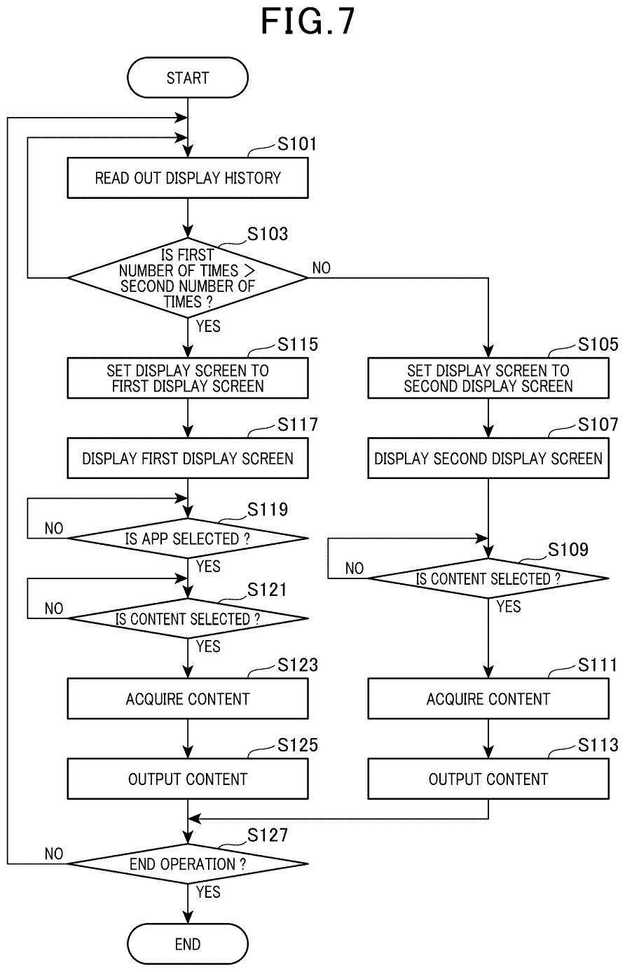

Next, processes of the display control device 2 will be described, by referring to FIG. 7. FIG. 7 is a flowchart showing an example of processes of the display control device 2. The flow chart of FIG. 7 is, for example, a flow chart showing an example of processes of the display control device 2 relating to the first embodiment.

In the flow chart shown in FIG. 7, a case will be described in which the sum TSS of the first cumulative time TS1 and the second cumulative time TS2 is equal to or more than the first time threshold TH1. The first time threshold TH1 is, for example, “24 hours”. The first cumulative time TS1 is a cumulative time that the first display screen DS1 is shown on the display DP. Moreover, the second cumulative time TS2 is a cumulative time that the second display screen DS2 is shown on the display DP. Moreover, in the flow chart shown in FIG. 7, a case will be described in which each of the first cumulative time TS1 and the second cumulative time TS2 is equal to or more than the second time threshold TH2.

In other words, a case will be described in which the history storage part 221 stores the first number of times NT1 of a sufficient number of times and the second number of times NT2 of a sufficient number of times, as the display history HS.

First, in step S101, the display setting part 212 reads out the display history HS from the history update part 213. The display history HS includes the first number of times NT1 and the second number of times NT2. The first number of times NT1 is a number of times that the user selects one app AP from among the apps AP of the first number N1, on the first display screen DS1. The second number of times NT2 is a number of times that the user selects one content C from among the contents C of the second number N2, on the second display screen DS2.

Next, in step S103, the display setting part 212 determines whether or not the first number of times NT1 is more numerous than the second number of times NT2.

In a case where the display setting part 212 determines that the first number of times NT1 is more numerous than the second number of times NT2 (step S103; YES), the process proceeds to step S115. In a case where the display setting part 212 determines that the first number of times NT1 is not more numerous than the second number of times NT2 (step S103; NO), the process proceeds to step S105.

Then, in step S105, the display setting part 212 sets the display screen DS to the second display screen DS2.

Next, in step S107, the display control part 211 displays the second display screen DS2 on the display DP.

Next, in step S109, the content acquisition part 214 determines whether or not an operation of a selection of the content C from the user is received, by the second display screen DS2.

In a case where the content acquisition part 214 determines that an operation of a selection of the content C is not received (step S109; NO), the process enters a standby state. In a case where the content acquisition part 214 determines that an operation of a selection of the content C is received (step S109; YES), the process proceeds to step S111.

Then, in step S111, the content acquisition part 214 communicatively connects to the server device 5 that provides the selected content C, and the content acquisition part 214 acquires the content C from the server device 5.

Next, in step S113, the content output part 215 outputs the content C acquired by the content acquisition part 214 to the output mechanism 3. Afterwards, the process proceeds to step S127.

In a case of YES in step S103, in step S115, the display setting part 212 sets the display screen DS to the first display screen DS1.

Next, in step S117, the display control part 211 displays the first display screen DS1 on the display DP.

Next, in step S119, the content acquisition part 214 determines whether or not an operation of a selection of the app AP from the user is received, by the first display screen DS1.

In a case where the content acquisition part 214 determines that an operation of a selection of the app AP is not received (step S119; NO), the process enters a standby state. In a case where the content acquisition part 214 determines that an operation of a selection of the app AP is received (step S119; YES), the process proceeds to step S121.

Then, in step S121, the content acquisition part 214 determines whether or not an operation of a selection of the content C from the user is received.

In a case where the content acquisition part 214 determines that an operation of a selection of the content C is not received (step S121; NO), the process enters a standby state. In a case where the content acquisition part 214 determines that an operation of a selection of the content C is received (step S121; YES), the process proceeds to step S123.

Then, in step S123, the content acquisition part 214 communicatively connects to the server device 5 that provides the selected content C, and the content acquisition part 214 acquires the content C from the server device 5.

Next, in step S125, the content output part 215 outputs the content C acquired by the content acquisition part 214 to the output mechanism 3. Afterwards, the process proceeds to step S127.

Next, in step S127, the display control device 2 determines whether or not to end the operation.

In a case where the display control device 2 determines not to end the operation (step S127; NO), the process returns to step S101. In a case where the display control device 2 determines to end the operation (step S127; YES), afterwards, the process ends.

Step S105 and step S115 each correspond to an example of a “setting step”.

### 4. Configuration and Effect

Heretofore, as described by referring to FIG. 1 to FIG. 7, a display control device 2 relating to the present embodiment includes a display control part 211 for displaying a first display screen DS1 or a second display screen DS2 on a display DP, the first display screen DS1 selectively displaying icons JA of a first number N1 of two or more that respectively correspond to apps AP of the first number N1, each of the apps AP being for distributing a content C, and the second display screen DS2 selectively displaying icons JC of a second number N2 of two or more that respectively correspond to contents C of the second number N2, a display setting part 212 for setting a display screen DS to be displayed on the display DP to the first display screen DS1 or the second display screen DS2, and a history storage part 221 for storing a display history HS of the first display screen DS1 and the second display screen DS2, in which the display setting part 212 sets the display screen DS to be displayed on the display DP to the first display screen DS1 or the second display screen DS2 based on the display history HS.

According to this configuration, the display control device 2 can set the display screen DS to be displayed on the display DP to the first display screen DS1 or the second display screen DS2, based on the display history HS. Therefore, the first display screen DS1 and the second display screen DS2 can be suitably set.

Moreover, in the display control device 2, the history storage part 221 stores a first number of times NT1 on the first display screen DS1 and a second number of times NT2 on the second display screen Ds2 as the display history HS, the first number of times NT1 being a number of times that a user selects one app AP from the apps AP of the first number N1, and the second number of times NT2 being a number of times that the user selects one content C from the contents C of the second number N2, and the display setting part 212 sets the display screen DS to a display screen DS corresponding to a more numerous number of times from among the first number of times NT1 and the second number of times NT2.

According to this configuration, the display screen DS to be displayed is set to a display screen DS corresponding to a more numerous number of times from among the first number of times NT1 and the second number of times NT2. The first number of times NT1 is a number of times that a user selects one app AP from the apps AP of the first number N1, on the first display screen DS1. The second number of times NT2 is a number of times that the user selects one content C from the content C of the second number N2, on the second display screen DS2. Therefore, the first display screen DS1 and the second display screen DS2 can be suitably set.

Moreover, in the display control device 2, each of the apps AP of the first number N1 is classified into one of a plurality of types TY, and each of the contents C of the second number N2 is classified into one of the plurality of types TY, the history storage part 221 stores a first selection number of times NS1 as the display history HS by classifying one app AP selected by a user for each of the plurality of types TY on the first display screen DS1, the first selection number of times NS1 being a number of times that the user selects the app AP, the history storage part 221 stores a second selection number of times NS2 as the display history by classifying one content C selected by the user for each of the plurality of types TY on the second display screen DS2, the second selection number of times NS2 being a number of times that the user selects the content C, the display setting part 212 obtains a sum NSS of the first selection number of times NS1 and the second selection number of times NS2, the first selection number of times NS1 corresponding to each of the plurality of types TY, and the second selection number of times NS2 corresponding to each of the plurality of types TY, and the display setting part 212 sets the display screen DS for the type TY with a most numerous sum NSS to a display screen DS corresponding to a more numerous selection number of times from among the first selection number of times NS1 and the second selection number of times NS2, in each of the plurality of types TY.

According to this configuration, the display control device 2 sets the display screen DS for the type TY with a most numerous sum NSS of the first selection number of times NS1 and the second selection number of times NS2 to a display screen DS corresponding to a more numerous selection number of times from among the first selection number of times NS1 and the second selection number of times NS2, in each of the plurality of types TY. The first selection number of times NS1 is a number of times that a user selects the app AP, by classifying one app AP selected by the user for each of the plurality of types TY, on the first display screen DS1. The second selection number of times NS2 is a number of times that the user selects the content C, by classifying one content C selected by the user for each of the plurality of types TY, on the second display screen DS2. Therefore, the first display screen DS1 and the second display screen DS2 can be suitably set.

Moreover, in the display control device 2, each of the apps AP of the first number N1 is classified into one of a plurality of types TY, and each of the contents C of the second number N2 is classified into one of the plurality of types TY, the history storage part 221 stores a first selection number of times NS1 as the display history HS by classifying one app AP selected by a user for each of the plurality of types TY on the first display screen DS1, the first selection number of times NS1 being a number of times that the user selects the app AP, the history storage part 221 stores a second selection number of times NS2 as the display history HS by classifying one content C selected by the user for each of the plurality of types TY on the second display screen DS2, the second selection number of times NS2 being a number of times that the user selects the content C, the display setting part 212 determines one type TY from among the plurality of types TY when the user selects the one app AP or the one content C, the one type TY corresponding to the selected app AP or content C, and the display setting part 212 determines a display screen DS corresponding to a more numerous selection number of times from among the first selection number of times NS1 and the second selection number of times NS2, the first selection number of times NS1 corresponding to the one type TY and the second selection number of times NS2 corresponding to the one type TY.

According to this configuration, the display control device 2 determines one type TY from among the plurality of types TY, the one type TY corresponding to the selected app AP or content C, and the display control device 2 sets the display screen DS to a display screen DS corresponding to a more numerous selection number of times from among the first selection number of times NS1 and the second selection number of times NS2, the first selection number of times NS1 corresponding to the one type TY and the second selection number of times NS2 corresponding to the one type TY. The first selection number of times NS1 is a number of times that a user selects the app AP, by classifying one app AP selected by the user for each of the plurality of types TY, on the first display screen DS1. The second selection number of times NS2 is a number of times that the user selects the content C, by classifying one content C selected by the user for each of the plurality of types TY, on the second display screen DS2. Therefore, the first display screen DS1 and the second display screen DS2 can be suitably set, in accordance with the one type TY corresponding to the selected app AP or content C.

Moreover, in the display control device 2, in a case where the display setting part 212 sets the first display screen DS1, the display control part 211 displays the first display screen DS1 in a first region AR1 set beforehand on the display DP, and in a case where the display setting part 212 sets the second display screen DS2, the display control part 211 displays the second display screen DS2 in a second region AR2 set beforehand on the display DP, the second region AR2 being different from the first region AR1.

According to this configuration, in a case where the display control device 2 sets the display screen DS to the first display screen DS1, the display control device 2 displays the first display screen DS1 in a first region AR1 set beforehand on the display DP. Moreover, in a case where the display control device 2 sets the display screen DS to the second display screen DS2, the display control device 2 displays the second display screen DS2 in a second region AR2 set beforehand on the display DP, the second region AR2 being different from the first region AR1. Therefore, the convenience of the user can be improved.

Moreover, in the display control device 2, the plurality of types TY includes video and music.

According to this configuration, the display control device 2 has the plurality of types TY including video and music. For example, the plurality of types TY are “video” and “music”. Both “video” and “music” are types TY with a more numerous frequency of the content C being output, compared to other types TY. Accordingly, the plurality of types TY can be suitably set. Therefore, the first selection number of times NS1 and the second selection number of times NS2 corresponding to the one type TY from among the plurality of types TY can be suitably stored. As a result of this, the first display screen DS1 and the second display screen DS2 can be suitably set.

Moreover, in the display control device 2, the history storage part 221 stores a first cumulative time TS1 and a second cumulative time TS2 as the display history HS, the first cumulative time TS1 being a cumulative time that the first display screen DS1 is displayed on the display DP, and the second cumulative time TS2 being a cumulative time that the second display screen DS2 is displayed on the display DP, and in a case where the sum TSS of the first cumulative time TS1 and the second cumulative time TS2 is equal to or more than a first time threshold TH1, the display setting part 212 sets the display screen DS to be displayed on the display DP to the first display screen DS1 or the second display screen DS2.

According to this configuration, in a case where a sum TSS of the first cumulative time TS1 and the second cumulative time TS2 is equal to or more than a first time threshold TH1, the display control device 2 sets the display screen DS to be displayed on the display DP to the first display screen DS1 or the second display screen DS2. The first cumulative time TS1 is a cumulative time that the first display screen DS1 is displayed on the display DP. The second cumulative time TS2 is a cumulative time that the second display screen DS2 is displayed on the display DP. Accordingly, in a case where a usage result of the first display screen DS1 and a usage result of the second display screen DS2 are sufficiently accumulated, by setting the first time threshold TH1 to a suitable value, the display control device 2 sets the display screen DS to the first display screen DS1 or the second display screen DS2. Therefore, the first display screen DS1 and the second display screen DS2 can be suitably set.

Moreover, in the display control device 2, in a case where the first cumulative time TS1 or the second cumulative time TS2 is less than a second time threshold TH2, the second time threshold TH2 being lower than the first time threshold TH1, the display setting part 212 sets the display screen DS to be displayed on the display DP to a display screen DS for which the cumulative time is less than the second time threshold TH2.

According to this configuration, in a case where the first cumulative time TS1 or the second cumulative time TS2 is less than a second time threshold TH2, the second time threshold TH2 being smaller than the first time threshold TH1, the display control device 2 sets the display screen DS to be displayed on the display DP to a display screen DS for which the cumulative time is less than the second time threshold TH2. Accordingly, the display screen DS for which the cumulative time is less than the second time threshold TH2 can be used by a user. Therefore, a usage result of the first display screen DS1 and a usage result of the second display screen DS2 can be set to a state where they are quickly and sufficiently accumulated, by suitably setting the second time threshold TH2. As a result of this, the convenience of the user can be improved.

Moreover, in the display control device 2, the first display screen DS1 or the second display screen DS2 is configured so that a display content is changed in association with identification information of a user, and the display setting part 212 sets with priority a display screen DS with the display content changed as the display screen DS to be displayed on the display DP.

According to this configuration, the display control device 2 sets with priority a display screen DS with a display content changed, in association with identification information of a user, as the display screen DS to be displayed on the display DP. Moreover, it is assumed that the display screen DS with the display content changed is easy to use by the user, in association with identification information of the user. Accordingly, the display screen DS assumed to be easy to use by the user can be set with priority. Therefore, the convenience of the user can be improved.

Moreover, in the display control device 2, the first display screen DS1 or the second display screen DS2 is configured so that a display content is changed in association with identification information of a user, and in a case where a display frequency PR of a display screen DS with the display content changed has an increasing tendency in the display history HS stored by the history storage part 221, the display setting part 212 sets the display screen DS with the display content changed as the display screen DS to be displayed on the display DP.

According to this configuration, in a case where a display frequency PR of a display screen DS with a display content changed has an increasing tendency, in association with identification information of a user, the display control device 2 sets the display screen DS with the display content changed, as the display screen DS to be displayed on the display DP. It is assumed that the display screen DS with the display content changed is easy to use by the user, in association with identification information of the user. Accordingly, in a case where a display frequency PR of the display screen DS with the display content changed has an increasing tendency, it is assumed that the user recognizes the ease of use of the display screen DS with the display content changed. Therefore, in this case, since the display screen DS with the display content changed is set, as the display screen DS to be displayed on the display DP, the convenience of the user can be improved.

Moreover, a display control method relating to the present embodiment is a display control method of a display control device 2 including: a display control part 211 for displaying a first display screen DS1 or a second display screen DS2 on a display DP, the first display screen DS1 selectively displaying icons JA of a first number N1 of two or more that respectively correspond to apps AP of the first number N1, each of the apps AP being for distributing a content C, and the second display screen DS2 selectively displaying icons JC of a second number N2 of two or more that respectively correspond to contents C of the second number N2, a display setting part 212 for setting a display screen DS to be displayed on the display DP to the first display screen DS1 or the second display screen DS2, and a history storage part 221 for storing a display history HS of the first display screen DS1 and the second display screen DS2, the display control method including performing a setting step of setting, by the display setting part 212, a display screen DS to be displayed on the display DP to the first display screen DS1 or the second display screen DS2 based on the display history HS.

Accordingly, the display control method relating to the present embodiment accomplishes a working effect the same as the working effect of the display control device 2 relating to the present embodiment.

Moreover, a control program PG relating to the present embodiment is a control program PG for causing a processor 21 of a display control device 2 to function as: a display control part 211 for displaying a first display screen DS1 or a second display screen DS2 on a display DP, the first display screen DS1 selectively displaying icons JA of a first number N1 of two or more that respectively correspond to apps AP of the first number N1, each of the apps AP being for distributing a content C, and the second display screen DS2 selectively displaying icons JC of a second number N2 of two or more that respectively correspond to contents C of the second number N2, a display setting part 212 for setting a display screen DS to be displayed on the display DP to the first display screen DS1 or the second display screen DS2, and a history storage part 221 for storing a display history HS of the first display screen DS1 and the second display screen DS2, in which the display setting part 212 sets the display screen DS to be displayed on the display DP to the first display screen DS1 or the second display screen DS2 based on the display history HS.

Accordingly, the control program PG relating to the present embodiment accomplishes a working effect the same as the working effect of the display control device 2 relating to the present embodiment.

### 5. Other Embodiments

The above-stated embodiments are preferred embodiments of the present invention. However, the present invention is not limited to the above-stated embodiments, and various modified examples are possible within a range that does not deviate from the content of the present invention.

In the present embodiment, while a case has been described in which the display control device 2 is mounted in the vehicle 100, the embodiment is not limited to this. The display control device 2 may be arranged, for example, in a television configured to be connectable to the internet. Moreover, the display control device 2 may be arranged, for example, in an “information processing device” such as a smartphone, a tablet computer, a laptop personal computer, or a desktop personal computer.

In the present embodiment, while a case has been described in which the plurality of types TY are “video” and “music”, the embodiment is not limited to this. The plurality of types TY may include “video” and “music”. For example, the plurality of types TY may be “video”, “music”, and “radio”.

In the present embodiment, while a case has been described in which the first display screen DS1 is an “Android TV (registered trademark)” display screen, and the second display screen DS2 is a “Google TV (registered trademark)” display screen, the embodiment is not limited to this. The first display screen DS1 may be an “app-based UI”, and the second display screen DS2 may be a “content-focused UI”. Note that, an “app-based UI” is called an “app-first UI”. Moreover, a “content-focused UI” is called a “content-first UI”.

For example, the display control device 2 shown in FIG. 2 shows a functional configuration, and the specific embodiment is not particularly limited. That is, it is not necessary for hardware individually corresponding to each functional part to be implemented, and it is possible for one processor to be set to a configuration for implementing functions of a plurality of functional parts by executing programs. Moreover, a part of the functions implemented by software in the embodiment described above may be implemented by hardware, or a part of the functions implemented by hardware may be implemented by software.

In the present embodiment, the display control device 2 includes a processor 21 and a memory 22, and while the processor 21 functions as various functional parts by reading and executing a control program PG, the embodiment is not limited to this.

The processor 21 may be configured of a single processor, or the processor 21 may be configured of a plurality of processors. The processor 21 may be hardware programmed so as to execute corresponding functional parts. That is, these processors may be configured, for example, of an ASIC (Application Specific Integrated Circuit) or a FPGA (Field Programmable Gate Array).

Moreover, the processing units of the flow chart shown in FIG. 7 are divided in accordance with the main processing contents, in order for the processes of the display control device 2 to be easily understood, and the present invention is not limited by the way of division and name of the processing units shown in the flow chart of FIG. 7. Moreover, the processes of the display control device 2 can be divided into further numerous processing units, in accordance with the processing contents, or the processes of the display control device 2 can be divided so that one processing unit includes more numerous processes. Moreover, the processing order of the flow chart described above is not limited to the illustrated example.

### 6. Configurations Supported by the Embodiments

The above-stated embodiments are specific examples of the following configurations.

(Configuration 1) A display control device including: a display control part for displaying a first display screen or a second display screen on a display, the first display screen selectively displaying icons of a first number of two or more that respectively correspond to apps of the first number, each of the apps being for distributing a content, and the second display screen selectively displaying icons of a second number of two or more that respectively correspond to contents of the second number, a display setting part for setting a display screen to be displayed on the display to the first display screen or the second display screen, and a history storage part for storing a display history of the first display screen and the second display screen, in which the display setting part sets the display screen to be displayed on the display to the first display screen or the second display screen based on the display history.

The display control device of Configuration 1 sets the display screen to be displayed on the display to the first display screen or the second display screen, based on the display history. Therefore, the first display screen and the second display screen can be suitably set.

(Configuration 2) The display control device described in Configuration 1, in which the history storage part stores a first number of times on the first display screen and a second number of times on the second display screen as the display history, the first number of times being a number of times that a user selects one app from the apps of the first number, and the second number of times being a number of times that the user selects one content from the contents of the second number, and the display setting part sets the display screen to a display screen corresponding to a more numerous number of times from among the first number of times and the second number of times.

The display control device of Configuration 2 can set the display screen to a display screen corresponding to a more numerous number of times from among the first number of times and the second number of times. The first number of times is a number of times that a user selects one app from the apps of the first number, on the first display screen. The second number of times is a number of times that the user selects one content from the content of the second number, on the second display screen. Therefore, the first display screen and the second display screen can be suitably set.

(Configuration 3) The display control device described in Configuration 1, in which each of the apps of the first number is classified into one of a plurality of types, and each of the contents of the second number is classified into one of the plurality of types, the history storage part stores a first selection number of times as the display history by classifying one app selected by a user for each of the plurality of types on the first display screen, the first selection number of times being a number of times that the user selects the app, the history storage part stores a second selection number of times as the display history by classifying one content selected by the user for each of the plurality of types on the second display screen, the second selection number of times being a number of times that the user selects the content, the display setting part obtains a sum of the first selection number of times and the second selection number of times, the first selection number of times corresponding to each of the plurality of types, and the second selection number of times corresponding to each of the plurality of types, and the display setting part sets the display screen for the type with a most numerous sum to a display screen corresponding to a more numerous selection number of times from among the first selection number of times and the second selection number of times in each of the plurality of types.

The display control device of Configuration 3 sets the display screen for the type with a most numerous sum of the first selection number of times and the second selection number of times to a display screen corresponding to a more numerous selection number of times from among the first selection number of times and the second selection number of times, in each of the plurality of types. The first selection number of times is a number of times that a user selects the app, by classifying one app selected by the user for each of the plurality of types, on the first display screen. The second selection number of times is a number of times that the user selects the content, by classifying one content selected by the user for each of the plurality of types, on the second display screen. Therefore, the first display screen and the second display screen can be suitably set.

(Configuration 4) The display control device described in Configuration 1, in which each of the apps of the first number is classified into one of a plurality of types, and each of the contents of the second number is classified into one of the plurality of types, the history storage part stores a first selection number of times as the display history by classifying one app selected by a user for each of the plurality of types on the first display screen, the first selection number of times being a number of times that the user selects the app, the history storage part stores a second selection number of times as the display history by classifying one content selected by the user for each of the plurality of types on the second display screen, the second selection number of times being a number of times that the user selects the content, the display setting part determines one type from among the plurality of types when the user selects the one app or the one content, the one type corresponding to the selected app or content, and the display setting part sets the display screen to a display screen corresponding to a more numerous selection number of times from among the first selection number of times and the second selection number of times, the first selection number of times corresponding to the one type and the second selection number of times corresponding to the one type.

The display control device of Configuration 4 determines one type from among the plurality of types, the one type corresponding to the selected app or content, and the display control device sets the display screen to a display screen corresponding to a more numerous selection number of times from among the first selection number of times and the second selection number of times, the first selection number of times corresponding to the one type and the second selection number of times corresponding to the one type. The first selection number of times is a number of times that a user selects the app, by classifying one app selected by the user for each of the plurality of types, on the first display screen. The second selection number of times is a number of times that the user selects the content, by classifying one content selected by the user for each of the plurality of types, on the second display screen. Therefore, the first display screen and the second display screen can be suitably set, in accordance with the one type corresponding to the selected app or content.

(Configuration 5) The display control device described in Configuration 4, in which in a case where the display setting part sets the first display screen, the display control part displays the first display screen in a first region set beforehand on the display, and in a case where the display setting part sets the second display screen, the display control part displays the second display screen in a second region set beforehand on the display, the second region being different from the first region.

In a case where the display control device of Configuration 5 sets the display screen to the first display screen, the display control device displays the first display screen in a first region set beforehand on the display. Moreover, in a case where the display control device sets the display screen to the second display screen, the display control device sets the second display screen in a second region set beforehand on the display, the second region being different from the first region. Therefore, the convenience of the user can be improved.

(Configuration 6) The display control device described in any one of Configuration 3 to Configuration 5, in which the plurality of types include video and music.

The display control device of Configuration 6 has the plurality of types including video and music. For example, the plurality of types are “video” and “music”. Both “video” and “music” are types with a more numerous frequency of the content being output, compared to other types. Accordingly, the plurality of types can be suitably set. Therefore, the first selection number of times and the second selection number of times corresponding to the one type from among the plurality of types can be suitably stored. As a result of this, the first display screen and the second display screen can be suitably set.

(Configuration 7) The display control device described in any one of Configuration 1 to Configuration 6, in which the history storage part stores a first cumulative time and a second cumulative time as the display history, the first cumulative time being a cumulative time that the first display screen is displayed on the display, and the second cumulative time being a cumulative time that the second display screen is displayed on the display, and in a case where a sum of the first cumulative time and the second cumulative time is equal to or more than a first time threshold, the display setting part sets the display screen to be displayed on the display to the first display screen or the second display screen.

In a case where a sum of the first cumulative time and the second cumulative time is equal to or more than a first time threshold, the display control device of Configuration 7 sets the display screen to be displayed on the display to the first display screen or the second display screen. The first cumulative time is a cumulative time that the first display screen is displayed on the display. The second cumulative time is a cumulative time that the second display screen is displayed on the display. Accordingly, in a case where a usage result of the first display screen and a usage result of the second display screen are sufficiently accumulated, by setting the first time threshold to a suitable value, the display control device sets the display screen to the first display screen or the second display screen. Therefore, the first display screen and the second display screen can be suitably set.

(Configuration 8) The display control device described in any one of Configuration 1 to Configuration 7, in which in a case where the first cumulative time or the second cumulative time is less than a second time threshold, the second time threshold being lower than the first time threshold, the display setting part sets the display screen to be displayed on the display to a display screen for which the cumulative time is less than the second time threshold.

In a case where the first cumulative time or the second cumulative time is less than a second time threshold, the second time threshold being smaller than the first time threshold, the display control device of Configuration 8 sets the display screen to be displayed on the display to a display screen for which the cumulative time is less than the second time threshold. Accordingly, the display screen for which the cumulative time is less than the second time threshold can be used by a user. Therefore, a usage result of the first display screen and a usage result of the second display screen can be set to a state where they are quickly and sufficiently accumulated, by suitably setting the second time threshold. As a result of this, the convenience of the user can be improved.

(Configuration 9) The display control device described in any one of Configuration 1 to Configuration 8, in which the first display screen or the second display screen is configured so that a display content is changed in association with identification information of a user, and the display setting part sets with priority a display screen with the display content changed as the display screen to be displayed on the display.

The display control device of Configuration 9 sets with priority a display screen with a display content changed, in association with identification information of a user, as the display screen to be displayed on the display. Moreover, it is assumed that the display screen with the display content changed is easy to use by the user, in association with identification information of the user. Accordingly, the display screen assumed to be easy to use by the user can be set with priority. Therefore, the convenience of the user can be improved.

(Configuration 10) The display control device described in any one of Configuration 1 to Configuration 9, in which the first display screen or the second display screen is configured so that a display content is changed in association with identification information of a user, and in a case where a display frequency of a display screen with a display content changed has an increasing tendency in the display history stored by the history storage part, the display setting part sets the display screen with the display content changed as the display screen to be displayed on the display.

In a case where a display frequency of a display screen with a display content changed has an increasing tendency, in association with identification information of a user, the display control device of Configuration 10 sets the display screen with the display content changed, as the display screen to be displayed on the display. It is assumed that the display screen with the display content changed is easy to use by the user, in association with identification information of the user. Accordingly, in a case where a display frequency of the display screen with the display content changed has an increasing tendency, it is assumed that the user recognizes the ease of use of the display screen with the display content changed. Therefore, in this case, since the display screen with the display content changed is set, as the display screen to be displayed on the display, the convenience of the user can be improved.

(Configuration 11) A display control method of a display control device including: a display control part for displaying a first display screen or a second display screen on a display, the first display screen selectively displaying icons of a first number of two or more that respectively correspond to apps of the first number, each of the apps being for distributing a content, and the second display screen selectively displaying icons of a second number of two or more that respectively correspond to contents of the second number, a display setting part for setting a display screen to be displayed on the display to the first display screen or the second display screen, and a history storage part for storing a display history of the first display screen and the second display screen, the display control method including performing a setting step of setting, by the display setting part, a display screen to be displayed on the display to the first display screen or the second display screen based on the display history.

Since the display control method of Configuration 11 has a configuration the same as the configuration of the display control device of Configuration 1, the display control method accomplishes a working effect the same as the working effect of the display control device relating to Configuration 1.

(Configuration 12) A non-transitory computer readable storage medium storing a display control program for causing a processor of a display control device to function as: a display control part for displaying a first display screen or a second display screen on a display, the first display screen selectively displaying icons of a first number of two or more that respectively correspond to apps of the first number, each of the apps being for distributing a content, and the second display screen selectively displaying icons of a second number of two or more that respectively correspond to contents of the second number, a display setting part for setting a display screen to be displayed on the display to the first display screen or the second display screen, and a history storage part for storing a display history of the first display screen and the second display screen, in which the display setting part sets the display screen to be displayed on the display to the first display screen or the second display screen based on the display history.

Since the storage medium of Configuration 12 has a configuration the same as the configuration of the display control device of Configuration 1, the display control program accomplishes a working effect the same as the working effect of the display control device of Configuration 1.

### REFERENCE SIGNS LIST

100 vehicle
1 seat
11 first seat
2 display control device
21 first processor (processor)
211 display control part
212 display setting part
213 history update part
214 content acquisition part
215 content output part
22 memory
221 history storage part
23 communication interface
3 output mechanism
31 first output mechanism
311 first touch panel
312 first speaker
5 server device
AP app
APN Nth app
AR1 first region
AR2 second region
C contents
CN Nth content
DP display
DS display screen
DS1 first display screen
DS2 second display screen
JA icon
JAN Nth icon
JC icon
JCN Nth icon
N1 first number
N2 second number
NS1 first selection number of times
NS2 second selection number of times
NSS sum
P passenger (user)
PG control program (display control program)
PR usage frequency
TH1 first time threshold
TH2 second time threshold
TS1 first cumulative time
TS2 second cumulative time
TSS sum
TY type

1. A display control device comprising:
a display control part for displaying a first display screen or a second display screen on a display, the first display screen selectively displaying icons of a first number of two or more that respectively correspond to apps of the first number, each of the apps being for distributing a content, and the second display screen selectively displaying icons of a second number of two or more that respectively correspond to contents of the second number;
a display setting part for setting a display screen to be displayed on the display to the first display screen or the second display screen; and
a history storage part for storing a display history of the first display screen and the second display screen, wherein
the display setting part sets the display screen to be displayed on the display to the first display screen or the second display screen based on the display history.

2. The display control device according to claim 1, wherein
the history storage part stores a first number of times on the first display screen and a second number of times on the second display screen as the display history, the first number of times being a number of times that a user selects one app from the apps of the first number, and the second number of times being a number of times that the user selects one content from the contents of the second number, and
the display setting part sets the display screen to a display screen corresponding to a more numerous number of times from among the first number of times and the second number of times.

3. The display control device according to claim 1, wherein
each of the apps of the first number is classified into one of a plurality of types, and each of the contents of the second number is classified into one of the plurality of types,
the history storage part stores a first selection number of times as the display history by classifying one app selected by a user for each of the plurality of types on the first display screen, the first selection number of times being a number of times that the user selects the app,
the history storage part stores a second selection number of times as the display history by classifying one content selected by the user for each of the plurality of types on the second display screen, the second selection number of times being a number of times that the user selects the content,
the display setting part obtains a sum of the first selection number of times and the second selection number of times, the first selection number of times corresponding to each of the plurality of types, and the second selection number of times corresponding to each of the plurality of types, and
the display setting part sets the display screen for the type with a most numerous sum to a display screen corresponding to a more numerous selection number of times from among the first selection number of times and the second selection number of times in each of the plurality of types.

4. The display control device according to claim 1, wherein
each of the apps of the first number is classified into one of a plurality of types, and each of the contents of the second number is classified into one of the plurality of types,
the history storage part stores a first selection number of times as the display history by classifying one app selected by a user for each of the plurality of types on the first display screen, the first selection number of times being a number of times that the user selects the app,
the history storage part stores a second selection number of times as the display history by classifying one content selected by the user for each of the plurality of types on the second display screen, the second selection number of times being a number of times that the user selects the content,
the display setting part determines one type from among the plurality of types when the user selects the one app or the one content, the one type corresponding to the selected app or content, and
the display setting part sets the display screen to a display screen corresponding to a more numerous selection number of times from among the first selection number of times and the second selection number of times, the first selection number of times corresponding to the one type and the second selection number of times corresponding to the one type.

5. The display control device according to claim 4, wherein
in a case where the display setting part sets the first display screen,
the display control part displays the first display screen in a first region set beforehand on the display, and
in a case where the display setting part sets the second display screen,
the display control part displays the second display screen in a second region set beforehand on the display, the second region being different from the first region.

6. The display control device according to claim 3, wherein
the plurality of types include video and music.

7. The display control device according to claim 1, wherein
the history storage part stores a first cumulative time and a second cumulative time as the display history, the first cumulative time being a cumulative time that the first display screen is displayed on the display, and the second cumulative time being a cumulative time that the second display screen is displayed on the display, and
in a case where a sum of the first cumulative time and the second cumulative time is equal to or more than a first time threshold, the display setting part sets the display screen to be displayed on the display to the first display screen or the second display screen.

8. The display control device according to claim 7, wherein
in a case where the first cumulative time or the second cumulative time is less than a second time threshold, the second time threshold being lower than the first time threshold,
the display setting part sets the display screen to be displayed on the display to a display screen for which the cumulative time is less than the second time threshold.

9. The display control device according to claim 1, wherein
the first display screen or the second display screen is configured so that a display content is changed in association with identification information of a user, and
the display setting part sets with priority a display screen with the display content changed as the display screen to be displayed on the display.

10. The display control device according to claim 1, wherein
the first display screen or the second display screen is configured so that a display content is changed in association with identification information of a user, and
in a case where a display frequency of a display screen with the display content changed has an increasing tendency in the display history stored by the history storage part,
the display setting part sets the display screen with the display content changed as the display screen to be displayed on the display.

11. A display control method of a display control device comprising:
a display control part for displaying a first display screen or a second display screen on a display, the first display screen selectively displaying icons of a first number of two or more that respectively correspond to apps of the first number, each of the apps being for distributing a content, and the second display screen selectively displaying icons of a second number of two or more that respectively correspond to contents of the second number;
a display setting part for setting a display screen to be displayed on the display to the first display screen or the second display screen; and
a history storage part for storing a display history of the first display screen and the second display screen, the display control method comprising performing a setting step of
setting, by the display setting part, a display screen to be displayed on the display to the first display screen or the second display screen based on the display history.

12. A non-transitory computer readable storage medium storing a display control program for causing a processor of a display control device to function as:
a display control part for displaying a first display screen or a second display screen on a display, the first display screen selectively displaying icons of a first number of two or more that respectively correspond to apps of the first number, each of the apps being for distributing a content, and the second display screen selectively displaying icons of a second number of two or more that respectively correspond to contents of the second number;
a display setting part for setting a display screen to be displayed on the display to the first display screen or the second display screen; and
a history storage part for storing a display history of the first display screen and the second display screen, wherein
the display setting part sets the display screen to be displayed on the display to the first display screen or the second display screen based on the display history.
